(19) United States
(12) Patent Application Publication
(10) Pub. No.: US 2022/0150269 A1
(43) Pub. Date: May 12, 2022

(54) METHODS AND SYSTEMS FOR TESTING NETWORK SECURITY

(71) Applicant: SECURIFUL INC, Arlington, VA (US)

(72) Inventor: Sveinung Arnes Eidissen, Arlington, VA (US)

(21) Appl. No.: 17/093,165

(22) Filed: Nov. 9, 2020

(51) Int. Cl. H04L 29/06

(52) U.S. Cl. CPC H04L 63/1433

(57) ABSTRACT

The present disclosure is directed to testing network security. In particular, the methods and systems of the present disclosure may: receive data describing one or more security tests configured to cause one or more computing devices to indirectly test security of at least a particular portion of one or more networks by communicating data to one or more remotely located computing devices via the at least a particular portion of the network(s); execute, based at least in part on the data describing the security test(s), one or more aspects of the security test(s) with respect to the at least a particular portion of the network(s); receive data describing one or more results of the security test(s); and generate, based at least in part on the data describing the result(s), data describing a graphical user interface (GUI).

### FIELD

The present disclosure relates generally to computer networks. More particularly, the present disclosure relates to methods and systems for testing network security.

### BACKGROUND

Computing devices (e.g., desktop computers, laptop computers, tablet computers, set-top devices, smartphones, wearable computing devices, and/or the like) are ubiquitous in modern society. They may support communications between their users, provide their users with entertainment, information about their environments, current events, the world at large, and/or the like. Such computing devices and the networks that interconnect them may be vulnerable to various security threats, which may be continuously evolving, difficult to detect in particular contexts, and/or the like.

### SUMMARY

Aspects and advantages of embodiments of the present disclosure will be set forth in part in the following description, or may be learned from the description, or may be learned through practice of the embodiments.

One example aspect of the present disclosure is directed to a method. The method may include receiving, by one or more computing devices, from one or more remotely located computing devices, and via one or more networks interfacing the computing device(s) and the remotely located computing device(s), data describing one or more security tests configured to cause the computing device(s) to indirectly test security of at least a particular portion of the network(s) by communicating data to the remotely located computing device(s) via the at least a particular portion of the network(s). The method may also include executing, by the computing device(s) and based at least in part on the data describing the security test(s), one or more aspects of the security test(s) with respect to the at least a particular portion of the network(s). The method may further include receiving, by the computing device(s), from the remotely located computing device(s), and via the network(s), data describing one or more results of the security test(s). The method may further include generating, by the computing device(s) and based at least in part on the data describing the result(s), data describing a graphical user interface (GUI).

Another example aspect of the present disclosure is directed to a system. The system may include one or more processors and a memory storing instructions that when executed by the processor(s) cause the system to perform operations. The operations may include generating data describing one or more security tests configured to cause one or more computing devices to indirectly test security of at least a particular portion of one or more networks interfacing the system and the computing device(s). The operations may also include communicating, to the computing device(s) and via the network(s), the data describing the security test(s). The operations may further include receiving, from the computing device(s) and via the network(s), data generated in association with the computing device(s) executing one or more aspects of the security test(s) with respect to the at least a particular portion of the network(s). The operations may further include generating, based at least in part on the data generated in association with the computing device(s) executing the aspect(s) of the security test(s), data describing one or more results of the security test(s). The operations may further include communicating, to the computing device(s) and via the network(s), the data describing the result(s) of the security test(s).

A further example aspect of the present disclosure is directed to one or more non-transitory computer-readable media. The non-transitory computer-readable media may comprise instructions that when executed by one or more computing devices cause the computing device(s) to perform operations. The operations may include receiving, from one or more remotely located computing devices and via one or more networks interfacing the computing device(s) and the remotely located computing device(s), data indicating one or more predetermined threat indicators and describing one or more security tests configured to cause the computing device(s) to indirectly test security of at least a particular portion of the network(s) by communicating data to the remotely located computing device(s) via the at least a particular portion of the network(s). The operations may also include executing, based at least in part on the data describing the security test(s), one or more aspects of the security test(s) with respect to the at least a particular portion of the network(s) by detecting data comprising at least one of the predetermined threat indicator(s) associated with a particular predetermined threat.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in this specification, which makes reference to the appended figures, in which:

FIG. 1 depicts an example computing environment according to example embodiments of the present disclosure;

FIGS. 2A-D depict an example event sequence according to example embodiments of the present disclosure;

FIGS. 3A-C depict example interfaces according to example embodiments of the present disclosure; and

FIGS. 4 and 5 depict example methods according to example embodiments of the present disclosure.

### DETAILED DESCRIPTION

Example aspects of the present disclosure are directed to testing network security. In particular, a user device (e.g., desktop computer, laptop computer, tablet computer, mobile device, and/or the like) may be configured to indirectly test at least a particular portion of one or more networks. For example, such network(s) may interface the user device with one or more remotely located computing devices (e.g., servers, and/or the like), which may communicate, to the user device, data describing one or more security tests. Based at least in part on such data, the user device may execute one or more aspects of the security test(s), which may include communicating with the remotely located computing device(s) via the at least a particular portion of the network(s). The user device may receive (e.g., from the remotely located computing devices, and/or the like) data describing one or more results of the tests, and based at least in part on such data, the user device may generate a graphical user interface (GUI) (e.g., indicating such result(s), and/or the like).

The technology described herein may provide a number of technical effects and benefits. For example, the technology described herein may enable a user (e.g., a network administrator, and/or the like) to efficiently perform multiple useful security tests with respect to one or more networks without the need for specialized knowledge, particularly with regard to aspects of such network(s) managed by proprietary hardware, software, and/or the like.

With reference now to the Figures, example embodiments of the present disclosure will be discussed in further detail.

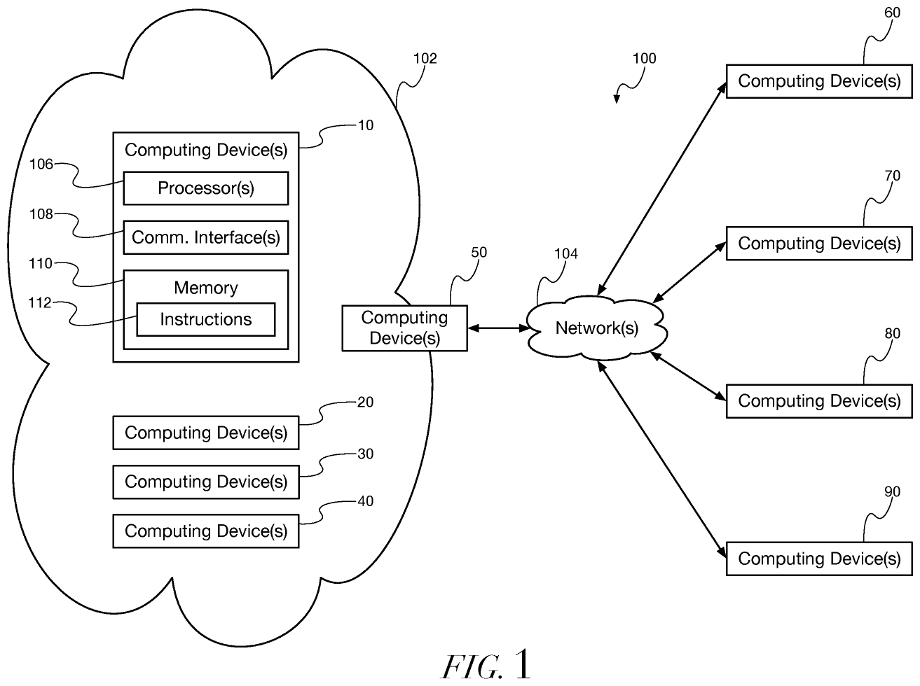

FIG. 1 depicts an example computing environment according to example embodiments of the present disclosure.

Referring to FIG. 1, environment 100 may include one or more computing devices (e.g., one or more desktop computers, laptop computers, set-top devices, tablet computers, mobile devices, smartphones, wearable devices, servers, network devices, network appliances, routers, switches, firewalls, filter devices, network-security devices, and/or the like). For example, environment 100 may include computing device(s) 10, 20, 30, 40, 50, 60, 70, 80, and/or 90, any one of which may include one or more associated and/or component computing devices (e.g., a mobile device and an associated wearable device, and/or the like). Environment 100 may also include one or more networks, for example, network(s) 102 and/or 104 (e.g., one or more wired networks, wireless networks, and/or the like). Network(s) 102 may interface computing device(s) 10, 20, 30, 40, and/or 50, with one another and/or computing device(s) 60, 70, 80, and/or 90 (e.g., via network(s) 104, and/or the like).

In some embodiments, network(s) 102 may comprise a distinctly identifiable local network (e.g., one or more local area network (LANs), associated with one or more organizations, and/or the like) that includes computing device(s) 10, 20, 30, 40, 50, and/or the like but does not include computing device(s) 60, 70, 80, 90, and/or the like, which may be remotely located from computing device(s) 10, 20, 30, 40, 50, and/or the like and may be interfaced with network(s) 102 (e.g., computing device(s) 10, 20, 30, 40, 50, and/or the like) via network(s) 104 (e.g., one or more wide area networks (WANs), the internet, and/or the like).

Computing device(s) 10 may include one or more processor(s) 106, one or more communication interfaces 108, and memory 110 (e.g., one or more hardware components for storing executable instructions, data, and/or the like). Communication interface(s) 108 may enable computing device(s) 10 to communicate with computing device(s) 20, 30, 40, 50, 60, 70, 80, and/or 90 (e.g., via network(s) 102, 104, and/or the like). Memory 110 may include (e.g., store, and/or the like) instructions 112. When executed by processor(s) 106, instructions 112 may cause computing device(s) 10 to perform one or more operations, functions, and/or the like described herein. It will be appreciated that computing device(s) 20, 30, 40, 50, 60, 70, 80, and/or 90 may include one or more of the components described above with respect to computing device(s) 10.

Unless explicitly indicated otherwise, the operations, functions, and/or the like described herein may be performed by computing device(s) 10, 20, 30, 40, 50, 60, 70, 80, and/or 90 (e.g., by computing device(s) 10, 20, 30, 40, 50, 60, 70, 80, or 90, by any combination of one or more of computing device(s) 10, 20, 30, 40, 50, 60, 70, 80, and/or 90, and/or the like).

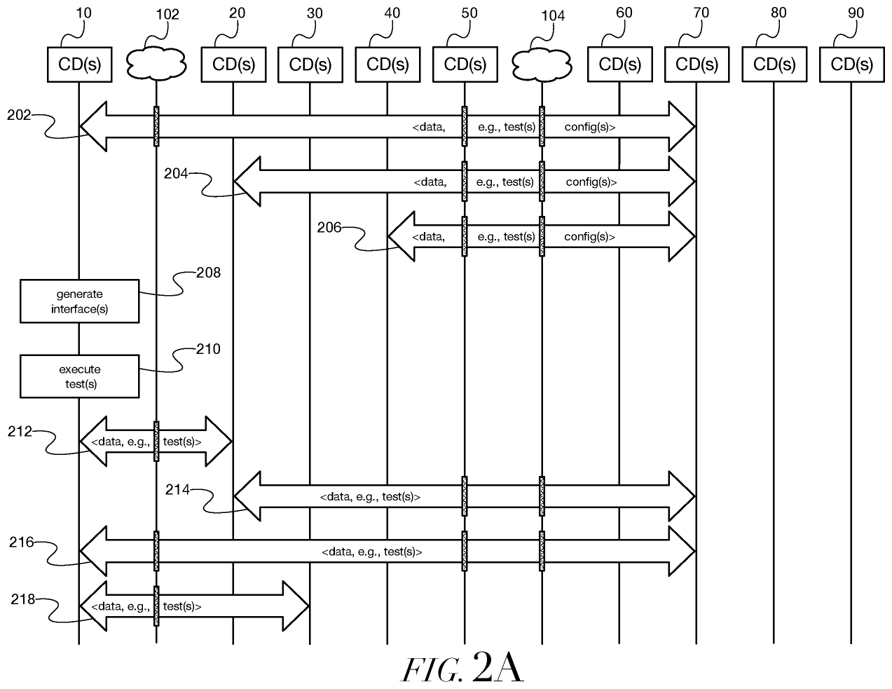

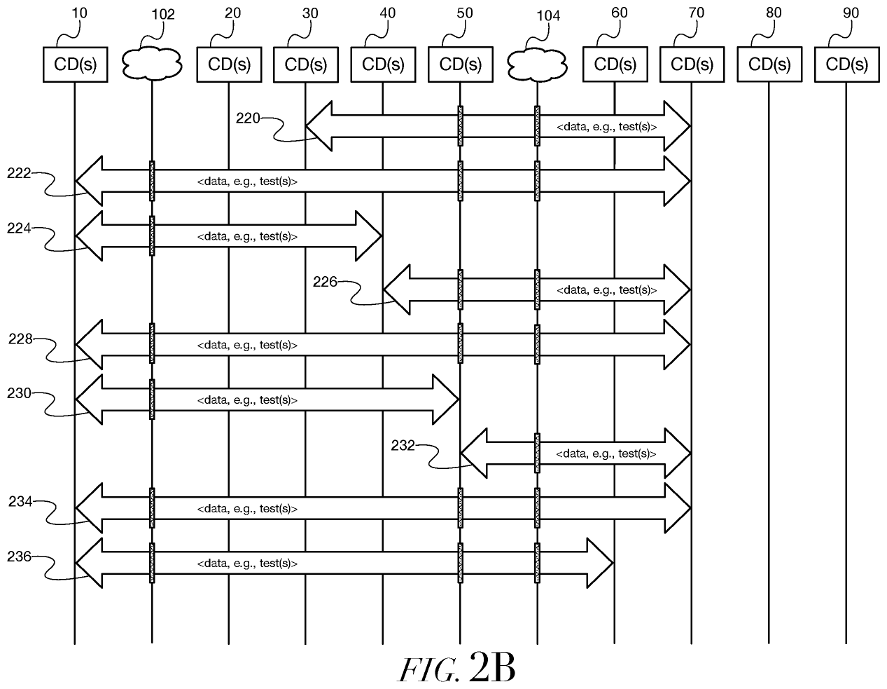

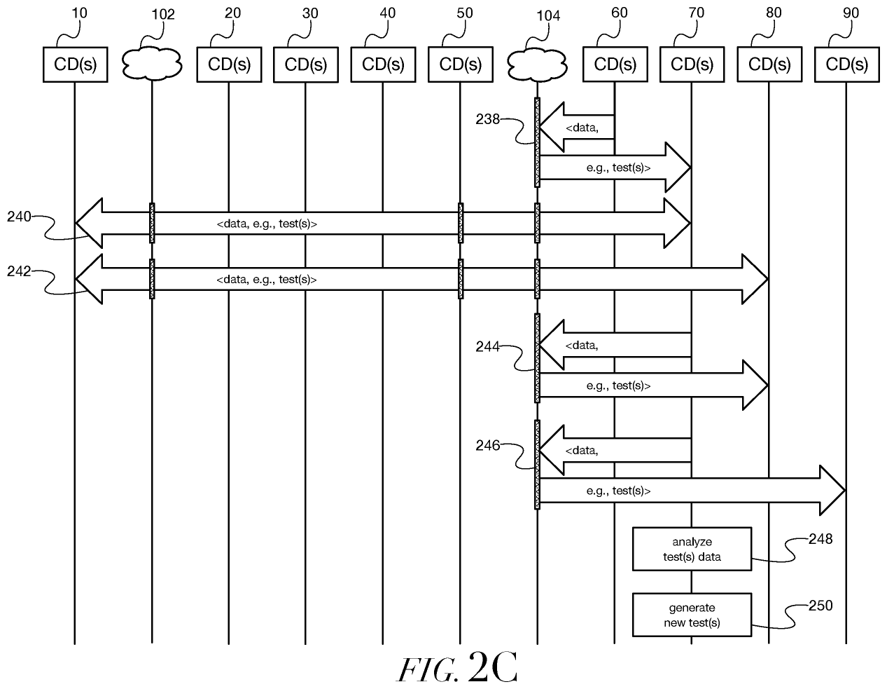

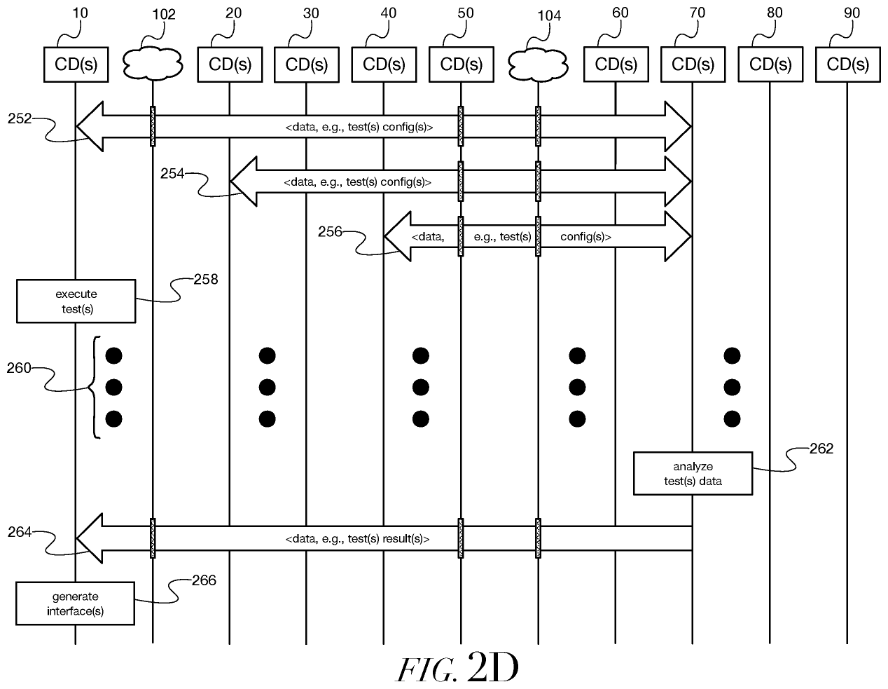

FIGS. 2A-D depict an example event sequence according to example embodiments of the present disclosure.

Referring to FIG. 2A, at (202), computing device(s) 10 and/or 70 may (e.g., via network(s) 102 and/or 104, computing device(s) 50, and/or the like (as indicated by the pattern-filled boxes over the lines extending downward from network(s) 102 and 104 and computing device(s) 50), and/or the like) communicate (e.g., generate, transmit, receive, and/or the like) data describing one or more security tests configured to cause computing device(s) 10 to indirectly test security of at least a particular portion of network(s) 102 and/or 104 by communicating data to computing device(s) 70 via the at least a particular portion of network(s) 102 and/or 104. For example, computing device(s) 70 (e.g., one or more servers, and/or the like) may be remotely located from computing device(s) 10 (e.g., one or more user computing devices, laptop computers, desktop computers, tablet computers, mobile devices, smartphones, and/or the like) and may provide one or more network-security-analysis services via one or more associated client applications, services, programs, routines, and/or the like installed on, provided to, executed by, and/or the like computing device(s) 10, and computing device(s) 10 and/or 70 may communicate data describing one or more such security tests provided, supported, configured, and/or the like by such network-security-analysis service(s), and/or the like.

As previously indicated, such security test(s) may be configured to cause computing device(s) 10 to indirectly test security of at least a particular portion of network(s) 102 and/or 104 by communicating data to computing device(s) 70 via the at least a particular portion of network(s) 102 and/or 104. For example, such security test(s) may be configured to cause computing device(s) 10 to indirectly test security of computing device(s) 50 (e.g., one or more edge network devices interfacing network(s) 102 and 104, one or more network firewall devices, intrusion detection devices, security information event management devices, network routing devices, data loss protection devices, anti-malware devices, anti-phishing devices, and/or the like) and/or computing device(s) 60 (e.g., one or more internet service provider (ISP) computing devices, domain name system (DNS) computing devices, and/or the like).

In some embodiments, the data describing such security test(s) may include data indicating one or more predetermined threat indicators associated with a particular predetermined threat. For example, such threat indicator(s) may include an internet protocol (IP) address associated with the particular predetermined threat, a domain name associated with the particular predetermined threat, a web-address reference associated with the particular predetermined threat, a file associated with the particular predetermined threat, a hash value generated based at least in part on a file associated with the particular predetermined threat, an operating system (OS) command associated with the particular predetermined threat, data from a DNS record associated with the particular predetermined threat, data indicating a secure sockets layer (SSL) certificate associated with the particular predetermined threat, data indicating a protocol payload associated with the particular predetermined threat, data indicating a query associated with the particular predetermined threat, and/or the like.

At (204), computing device(s) 20 and/or 70 may communicate data describing one or more security tests configured to cause computing device(s) 20 to indirectly test security of at least a particular portion of network(s) 102 and/or 104 by communicating data to computing device(s) 70 via the at least a particular portion of network(s) 102 and/or 104. For example, computing device(s) 70 (e.g., one or more servers, and/or the like) may be remotely located from computing device(s) 20 (e.g., one or more user computing devices, laptop computers, desktop computers, tablet computers, mobile devices, smartphones, and/or the like) and may provide one or more network-security-analysis services via one or more associated client applications, services, programs, routines, and/or the like installed on, provided to, executed by, and/or the like computing device(s) 20, and computing device(s) 20 and/or 70 may communicate data describing one or more such security tests provided, supported, configured, and/or the like by such network-security-analysis service(s), and/or the like.

Similarly, at (206), computing device(s) 40 and/or 70 may communicate data describing one or more security tests configured to cause computing device(s) 40 to indirectly test security of at least a particular portion of network(s) 102 and/or 104 by communicating data to computing device(s) 70 via the at least a particular portion of network(s) 102 and/or 104. For example, computing device(s) 70 (e.g., one or more servers, and/or the like) may be remotely located from computing device(s) 40 (e.g., one or more network appliances, dedicated application devices, and/or the like) and may provide one or more network-security-analysis services via one or more associated client applications, services, programs, routines, and/or the like installed on, provided to, executed by, and/or the like computing device(s) 40, and computing device(s) 40 and/or 70 may communicate data describing one or more such security tests provided, supported, configured, and/or the like by such network-security-analysis service(s), and/or the like.

At (208), computing device(s) 10 (e.g., one or more of the client application(s), service(s), program(s), routine(s), and/or the like installed on, provided to, executed by, and/or the like computing device(s) 10, and/or the like) may generate data describing one or more graphical user interfaces (GUIs) associated with the network-security-analysis services provided by computing device(s) 70, and/or the like.

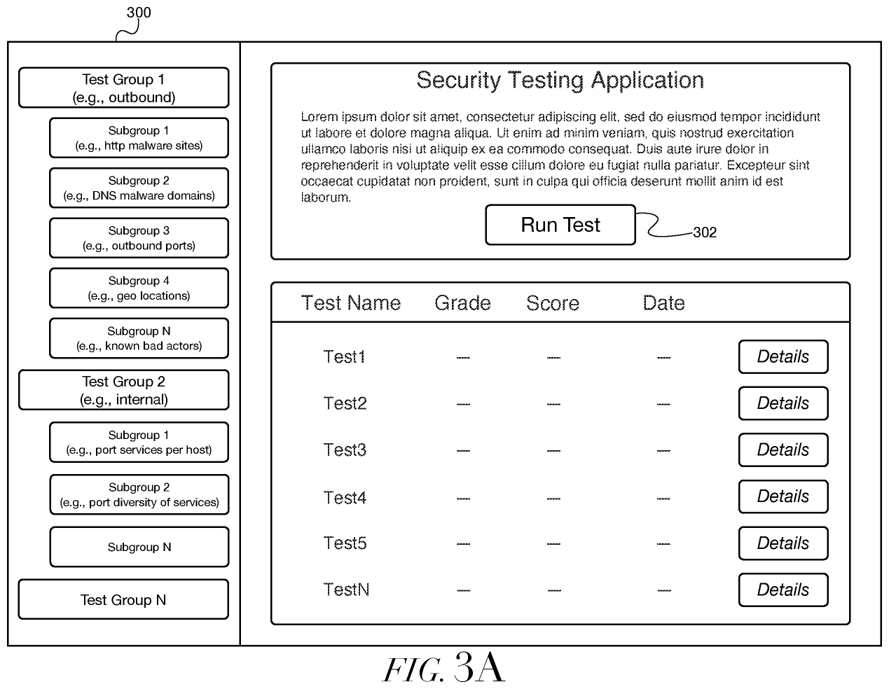

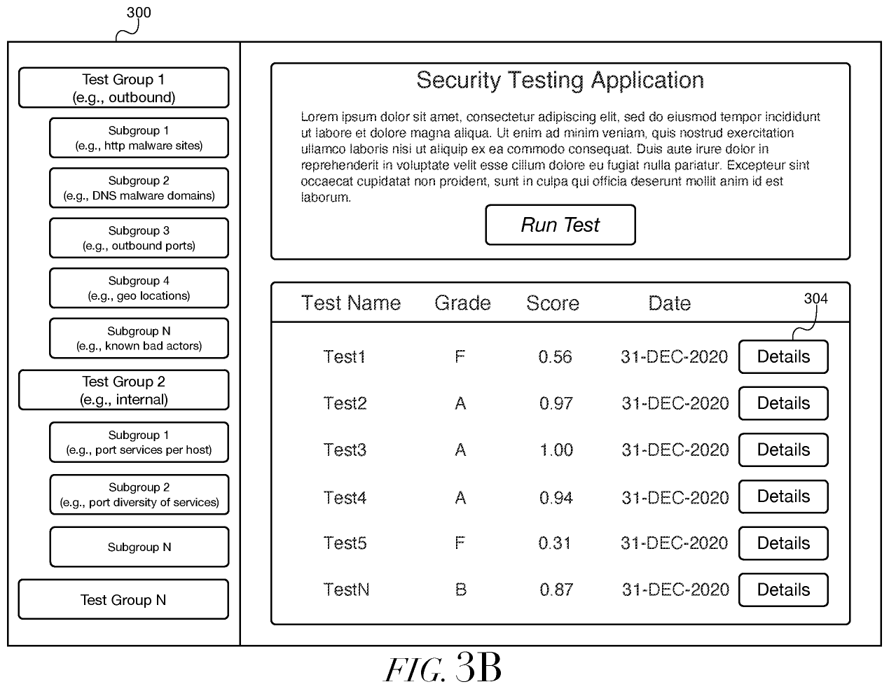

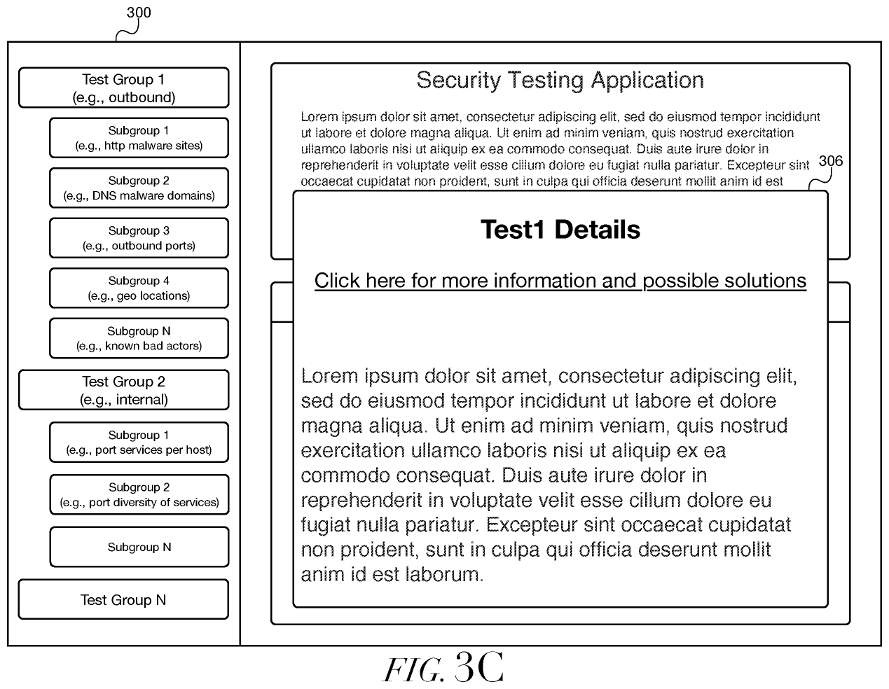

For example, referring to FIG. 3A, computing device(s) 10 may generate data describing interface 300. As illustrated, interface 300 may include a grouped listing of provided network-security-analysis tests (e.g., based at least in part on the data communicated at (202), and/or the like), a listing of results associated with such tests, as well as element 302, which when invoked (e.g., via user interaction with element 302, and/or the like) may, returning to FIG. 2A, at (210), cause computing device(s) 10 to initiate execution of one or more aspects of such test(s).

At (212), computing device(s) 10 and/or 20 may communicate data associated with one or more of the security test(s). For example, computing device(s) 10 may determine computing device(s) 20 include the associated client application(s), service(s), program(s), routine(s), and/or the like installed on, provided to, executed by, and/or the like computing device(s) 20, and (e.g., responsive thereto, and/or the like) computing device(s) 10 may perform one or more port scans and/or the like of computing device(s) 20.

At (214), computing device(s) 20 and/or 70 may communicate data associated with one or more of the security test(s). For example, computing device(s) 70 may determine computing device(s) 20 include the associated client application(s), service(s), program(s), routine(s), and/or the like installed on, provided to, executed by, and/or the like computing device(s) 20, and (e.g., responsive thereto, and/or the like) computing device(s) 70 may perform one or more port scans and/or the like of computing device(s) 20.

At (216), computing device(s) 10 and/or 70 may communicate data associated with one or more of the security test(s). For example, computing device(s) 10 and/or 70 may communicate data based at least in part on data communicated at (212), and/or the like.

At (218), computing device(s) 10 and/or 30 may communicate data associated with one or more of the security test(s). For example, computing device(s) 10 may identify, discover, detect, and/or the like computing device(s) 30 irrespective of whether computing device(s) 30 include the associated client application(s), service(s), program(s), routine(s), and/or the like, and (e.g., responsive thereto, and/or the like) computing device(s) 10 may determine, detect, identify, and/or the like one or more particular operating system (OS) configurations, registry entries, overly permissive network shares, and/or the like associated with computing device(s) 30.

Referring to FIG. 2B, at (220), computing device(s) 30 and/or 70 may communicate data associated with one or more of the security test(s). For example, computing device(s) 70 may identify, discover, detect, and/or the like computing device(s) 30 irrespective of whether computing device(s) 30 include the associated client application(s), service(s), program(s), routine(s), and/or the like, and (e.g., responsive thereto, and/or the like) computing device(s) 70 may determine, detect, identify, and/or the like one or more particular OS configurations, registry entries, overly permissive network shares, and/or the like associated with computing device(s) 30.

At (222), computing device(s) 10 and/or 70 may communicate data associated with one or more of the security test(s). For example, computing device(s) 10 and/or 70 may communicate data based at least in part on data communicated at (218), and/or the like.

At (224), computing device(s) 10 and/or 40 may communicate data associated with one or more of the security test(s). For example, computing device(s) 40 may determine computing device(s) 10 include the associated client application(s), service(s), program(s), routine(s), and/or the like installed on, provided to, executed by, and/or the like computing device(s) 10, and (e.g., responsive thereto, and/or the like) computing device(s) 40 may perform one or more port scans and/or the like of computing device(s) 10, may determine, detect, identify, and/or the like one or more particular vulnerable application versions, patches, and/or the like.

At (226), computing device(s) 40 and/or 70 may communicate data associated with one or more of the security test(s). For example, computing device(s) 70 may determine computing device(s) 40 include the associated client application(s), service(s), program(s), routine(s), and/or the like installed on, provided to, executed by, and/or the like computing device(s) 40, and (e.g., responsive thereto, and/or the like) computing device(s) 70 may perform one or more port scans and/or the like of computing device(s) 40, may determine, detect, identify, and/or the like one or more particular vulnerable application versions, patches, and/or the like.

At (228), computing device(s) 10 and/or 70 may communicate data associated with one or more of the security test(s). For example, computing device(s) 10 and/or 70 may communicate data based at least in part on data communicated at (224), and/or the like.

At (230), computing device(s) 10 and/or 50 may communicate data associated with one or more of the security test(s). For example, computing device(s) 10 may communicate data toward computing device(s) 70 via computing device(s) 50 to determine, detect, infer, and/or the like whether computing device(s) 50 will identify, detect, filter, block, and/or the like particular data based on its content, format, type, destination, and/or the like.

At (232), computing device(s) 50 and/or 70 may communicate data associated with one or more of the security test(s). For example, computing device(s) 50 and/or 70 may communicate data based at least in part on data communicated at (230), and/or the like.

At (234), computing device(s) 10 and/or 70 may communicate data associated with one or more of the security test(s). For example, computing device(s) 10 and/or 70 may communicate data based at least in part on data communicated at (230), (232), and/or the like.

At (236), computing device(s) 10 and/or 60 may communicate data associated with one or more of the security test(s). For example, computing device(s) 10 may communicate one or more DNS queries to computing device(s) 60, which responsive thereto, may communicate one or more DNS resolutions to computing device(s) 10.

Referring to FIG. 2C, at (238), computing device(s) 60 and/or 70 may communicate data associated with one or more of the security test(s). For example, computing device(s) 60 and/or 70 may communicate data based at least in part on data communicated at (236), and/or the like.

At (240), computing device(s) 10 and/or 70 may communicate data associated with one or more of the security test(s). For example, computing device(s) 10 and/or 70 may communicate data based at least in part on data communicated at (236), (238), and/or the like.

At (242), computing device(s) 10 and/or 80 may communicate data associated with one or more of the security test(s). For example, computing device(s) 10 may communicate (e.g., based at least in part on the DNS resolution(s), and/or the like) one or more resource requests to computing device(s) 80, which responsive thereto, may communicate data associated with the requested resource(s), and/or the like) to computing device(s) 10. In some embodiments, computing device(s) 80 may be associated with a third-party (e.g., website host, and/or the like), not affiliated with network(s) 102, computing device(s) 70, and/or the like.

At (244), computing device(s) 70 and/or 80 may communicate data associated with one or more of the security test(s). For example, computing device(s) 70 may communicate (e.g., based at least in part on the DNS resolution(s), and/or the like) one or more resource requests to computing device(s) 80, which responsive thereto, may communicate data associated with the requested resource(s), and/or the like) to computing device(s) 70.

At (246), computing device(s) 70 and/or 90 may communicate data associated with one or more of the security test(s). For example, computing device(s) 70 may communicate (e.g., based at least in part on the DNS resolution(s), one or more references included in the data associated with the requested resources at (244), and/or the like) one or more resource requests to computing device(s) 90, which responsive thereto, may communicate data associated with the requested resource(s), and/or the like) to computing device(s) 70. In some embodiments, computing device(s) 90 may be associated with one or more predetermined threat indicators, suspected or known to be associated with one or more malicious actors, and/or the like. In some of such embodiments, computing device(s) 70 may load (e.g., for analysis, and/or the like) at least a portion of the data associated with the requested resources at (246), and/or the like in a controlled and isolated computing environment (e.g., a specialized virtual computing environment, and/or the like) thereby isolating other aspects of computing device(s) 70, as well as network(s) 102, from potentially malicious data, and/or the like.

At (248), computing device(s) 70 may analyze the data associated with the security test(s). For example, computing device(s) 70 may analyze data associated with loading the at least a portion of the data associated with the requested resources at (246), and/or the like in the controlled and isolated computing environment, may detect one or more of the predetermined threat indicator(s) associated with one or more particular predetermined threats, may correlate, analyze, and/or the like results from various port scans, OS configurations, registry entries, overly permissive shares, application versions, settings, patches, and/or the like.

At (250), computing device(s) 70 may generate, based at least in part on one or more results from the analysis at (248) (e.g., dynamically, and/or the like), data describing one or more new security tests configured to cause computing device(s) 10 to indirectly test security of at least a particular portion of network(s) 102 and/or 104 by communicating data to computing device(s) 70 via the at least a particular portion of network(s) 102 and/or 104.

Referring to FIG. 2D, at (252), computing device(s) 10 and/or 70 may communicate data describing one or more of the new security test(s) configured to cause computing device(s) 10 to indirectly test security of the at least a particular portion of network(s) 102 and/or 104 by communicating data to computing device(s) 70 via the at least a particular portion of network(s) 102 and/or 104.

Similarly, at (254), computing device(s) 20 and/or 70 may communicate data describing one or more of the new security test(s) configured to cause computing device(s) 20 to indirectly test security of at least a particular portion of network(s) 102 and/or 104 by communicating data to computing device(s) 70 via the at least a particular portion of network(s) 102 and/or 104; and, at (256), computing device(s) 40 and/or 70 may communicate data describing one or more the new security test(s) configured to cause computing device(s) 40 to indirectly test security of at least a particular portion of network(s) 102 and/or 104 by communicating data to computing device(s) 70 via the at least a particular portion of network(s) 102 and/or 104.

At (258), computing device(s) 10, 70, and/or the like may initiate execution of one or more aspects of such new test(s).

At (260), computing device(s) 10, 20, 30, 40, 50, 60, 70, 80, 90, and/or the like may communicate data associated with one or more of the security test(s). For example, computing device(s) 10, 20, 30, 40, 50, 60, 70, 80, 90, and/or the like may communicate data similar to that described with respect to (212)-(246), and/or the like.

At (262), computing device(s) 70 may analyze the data associated with the new security test(s).

At (264), computing device(s) 70 may communicate data describing one or more results of the security test(s), the new security test(s), and/or the like to computing device(s) 10, which may receive such data.

At (266), computing device(s) 10, based at least in part on the data describing the result(s) of the security test(s), the new security test(s), and/or the like, may generate data describing one or more GUIs associated with the network-security-analysis services provided by computing device(s) 70, and/or the like.

For example, referring to FIG. 3B, computing device(s) 10 may generate data describing interface 300. As illustrated, interface 300 may include a listing of results associated with such tests, as well as element 304, which when invoked (e.g., via user interaction with element 304, and/or the like) may, referring to FIG. 3C, cause interface 300 to include element 306, which may depict one or more details with respect to one or more selected test results, and/or the like.

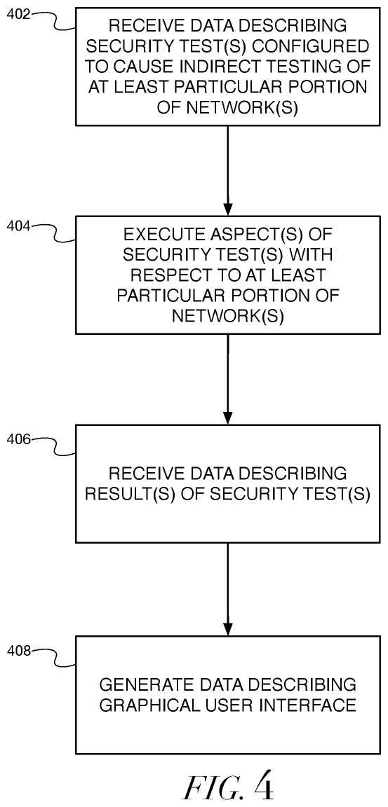

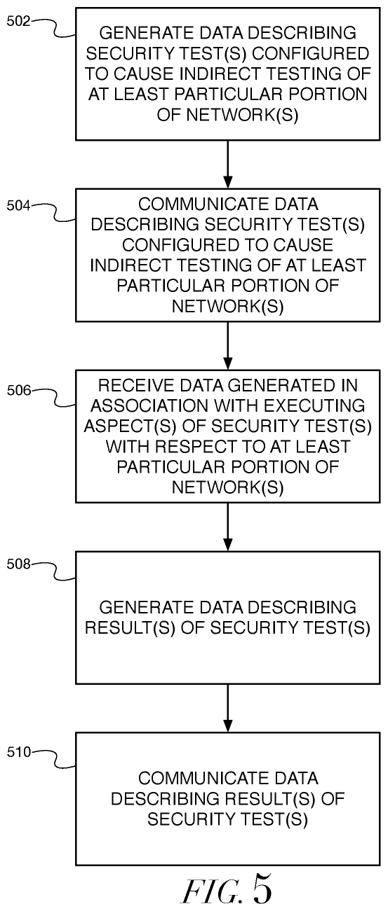

FIGS. 4 and 5 depict example methods according to example embodiments of the present disclosure.

Referring to FIG. 4, at (402), one or more computing devices may receive, from one or more remotely located computing devices and via one or more networks interfacing the computing device(s) and the remotely located computing device(s), data describing one or more security tests configured to cause the computing device(s) to indirectly test security of at least a particular portion of the network(s) by communicating data to the remotely located computing device(s) via the at least a particular portion of the network(s). For example, computing device(s) 10 may receive, from computing device(s) 70 and via network(s) 102 and/or 104, data describing one or more security tests configured to cause computing device(s) 10 to indirectly test security of at least a particular portion of network(s) 102 and/or 104 by communicating data to computing device(s) 70 via the at least a particular portion of network(s) 102 and/or 104.

At (404), the computing device(s) may execute, based at least in part on the data describing the security test(s), one or more aspects of the security test(s) with respect to the at least a particular portion of the network(s). For example, computing device(s) 10 may execute, based at least in part on the data describing the security test(s), one or more aspects of the security test(s) with respect to the at least a particular portion of network(s) 102 and/or 104.

At (406), the computing device(s) may receive, from the remotely located computing device(s) and via the network(s), data describing one or more results of the security test(s). For example, computing device(s) 10 may receive, from computing device(s) 70 and via network(s) 102 and/or 104, data describing one or more results of the security test(s).

At (408), the computing device(s) may generate, based at least in part on the data describing the result(s), data describing a graphical user interface (GUI). For example, computing device(s) 10 may generate, based at least in part on the data describing the result(s), data describing interface 300, and/or the like.

Referring to FIG. 5, at (502), a computing system (e.g., one or more associated computing devices, and/or the like) may generate data describing one or more security tests configured to cause one or more computing devices to indirectly test security of at least a particular portion of one or more networks interfacing the system and the computing device(s). For example, computing device(s) 70 may generate data describing one or more security tests configured to cause computing device(s) 10 to indirectly test security of at least a particular portion of network(s) 102 and/or 104.

At (504), the computing system may communicate, to the computing device(s) and via the network(s), the data describing the security test(s). For example, computing device(s) 70 may communicate, to computing device(s) 10 and via network(s) 102 and/or 104, the data describing the security test(s).

At (506), the computing system may receive, from the computing device(s) and via the network(s), data generated in association with the computing device(s) executing one or more aspects of the security test(s) with respect to the at least a particular portion of the network(s). For example, computing device(s) 70 may receive, from computing device(s) 10 and via network(s) 102 and/or 104, data generated in association with computing device(s) 10 executing one or more aspects of the security test(s) with respect to the at least a particular portion of network(s) 102 and/or 104.

At (508), the computing system may generate, based at least in part on the data generated in association with the computing device(s) executing the aspect(s) of the security test(s), data describing one or more results of the security test(s). For example, computing device(s) 70 may generate, based at least in part on the data generated in association with computing device(s) 10 executing the aspect(s) of the security test(s), data describing one or more results of the security test(s).

At (510), the computing system may communicate, to the computing device(s) and via the network(s), the data describing the result(s) of the security test(s). For example, computing device(s) 70 may communicate, to computing device(s) 10 and via network(s) 102 and/or 104, the data describing the result(s) of the security test(s).

The technology discussed herein makes reference to servers, databases, software applications, and/or other computer-based systems, as well as actions taken and information sent to and/or from such systems. The inherent flexibility of computer-based systems allows for a great variety of possible configurations, combinations, and/or divisions of tasks and/or functionality between and/or among components. For instance, processes discussed herein may be implemented using a single device or component and/or multiple devices or components working in combination. Databases and/or applications may be implemented on a single system and/or distributed across multiple systems. Distributed components may operate sequentially and/or in parallel.

Various connections between elements are discussed in the above description. These connections are general and, unless specified otherwise, may be direct and/or indirect, wired and/or wireless. In this respect, the specification is not intended to be limiting.

The depicted and/or described steps are merely illustrative and may be omitted, combined, and/or performed in an order other than that depicted and/or described; the numbering of depicted steps is merely for ease of reference and does not imply any particular ordering is necessary or preferred.

The functions and/or steps described herein may be embodied in computer-usable data and/or computer-executable instructions, executed by one or more computers and/or other devices to perform one or more functions described herein. Generally, such data and/or instructions include routines, programs, objects, components, data structures, or the like that perform particular tasks and/or implement particular data types when executed by one or more processors of a computer and/or other data-processing device. The computer-executable instructions may be stored on a computer-readable medium such as a hard disk, optical disk, removable storage media, solid-state memory, read-only memory (ROM), random-access memory (RAM), or the like. As will be appreciated, the functionality of such instructions may be combined and/or distributed as desired. In addition, the functionality may be embodied in whole or in part in firmware and/or hardware equivalents, such as integrated circuits, application-specific integrated circuits (ASICs), field-programmable gate arrays (FPGAs), or the like. Particular data structures may be used to more effectively implement one or more aspects of the disclosure, and such data structures are contemplated to be within the scope of computer-executable instructions and/or computer-usable data described herein.

Although not required, one of ordinary skill in the art will appreciate that various aspects described herein may be embodied as a method, system, apparatus, and/or one or more computer-readable media storing computer-executable instructions. Accordingly, aspects may take the form of an entirely hardware embodiment, an entirely software embodiment, an entirely firmware embodiment, and/or an embodiment combining software, hardware, and/or firmware aspects in any combination.

As described herein, the various methods and acts may be operative across one or more computing devices and/or networks. The functionality may be distributed in any manner or may be located in a single computing device (e.g., server, client computer, user device, or the like).

Aspects of the disclosure have been described in terms of illustrative embodiments thereof. Numerous other embodiments, modifications, and/or variations within the scope and spirit of the appended claims may occur to persons of ordinary skill in the art from a review of this disclosure. For example, one of ordinary skill in the art may appreciate that the steps depicted and/or described may be performed in other than the recited order and/or that one or more illustrated steps may be optional and/or combined. Any and all features in the following claims may be combined and/or rearranged in any way possible.

While the present subject matter has been described in detail with respect to various specific example embodiments thereof, each example is provided by way of explanation, not limitation of the disclosure. Those skilled in the art, upon attaining an understanding of the foregoing, may readily produce alterations to, variations of, and/or equivalents to such embodiments. Accordingly, the subject disclosure does not preclude inclusion of such modifications, variations, and/or additions to the present subject matter as would be readily apparent to one of ordinary skill in the art. For instance, features illustrated and/or described as part of one embodiment may be used with another embodiment to yield a still further embodiment. Thus, it is intended that the present disclosure cover such alterations, variations, and/or equivalents.

What is claimed is:

1. A method comprising:
receiving, by one or more computing devices, from one or more remotely located computing devices, and via one or more networks interfacing the one or more computing devices and the one or more remotely located computing devices, data describing one or more security tests configured to cause the one or more computing devices to indirectly test security of at least a particular portion of the one or more networks by communicating data to the one or more remotely located computing devices via the at least a particular portion of the one or more networks;
executing, by the one or more computing devices and based at least in part on the data describing the one or more security tests, one or more aspects of the one or more security tests with respect to the at least a particular portion of the one or more networks;
receiving, by the one or more computing devices, from the one or more remotely located computing devices, and via the one or more networks, data describing one or more results of the one or more security tests; and
generating, by the one or more computing devices and based at least in part on the data describing the one or more results, data describing a graphical user interface (GUI).

2. The method of claim 1, wherein:
receiving the data describing the one or more security tests comprises receiving data indicating one or more predetermined threat indicators; and
executing the one or more aspects of the one or more security tests comprises detecting data comprising at least one of the one or more predetermined threat indicators associated with a particular predetermined threat.

3. The method of claim 2, wherein the at least one of the one or more predetermined threat indicators comprises:
an internet protocol (IP) address associated with the particular predetermined threat;
a domain name associated with the particular predetermined threat;
a web-address reference associated with the particular predetermined threat;
a file associated with the particular predetermined threat;
a hash value generated based at least in part on a file associated with the particular predetermined threat;
an operating system (OS) command associated with the particular predetermined threat;
data from a domain name system (DNS) record associated with the particular predetermined threat;
data indicating a secure sockets layer (SSL) certificate associated with the particular predetermined threat;
data indicating a protocol payload associated with the particular predetermined threat; or
data indicating a query associated with the particular predetermined threat.

4. The method of claim 1, wherein the at least a particular portion of the one or more networks comprises one or more:
network firewall devices;
intrusion detection devices;
security information event management devices;
network routing devices;
data loss protection devices;
anti-malware devices; or
anti-phishing devices.

5. The method of claim 1, wherein the one or more networks comprise a distinctly identifiable local network that:
comprises the one or more computing devices;
comprises the at least a particular portion of the one or more networks; and
does not comprise the one or more remotely located computing devices.

6. The method of claim 5, wherein:
the one or more computing devices include at least two different and physically distinct computing devices; and
executing the one or more aspects of the one or more security tests comprises:
communicating, by a first of the at least two different and physically distinct computing devices, to the one or more remotely located computing devices, and via the one or more networks, data associated with the one or more security tests;
communicating, by the first of the at least two different and physically distinct computing devices, to a second of the at least two different and physically distinct computing devices, and via the distinctly identifiable local network, different data associated with the one or more security tests; and
communicating, by the second of the at least two physically distinct computing devices, to the one or more remotely located computing devices, and via the one or more networks, data generated based at least in part on the different data associated with the one or more security tests.

7. The method of claim 6, wherein receiving the data describing the one or more results of the one or more security tests comprises receiving, by the first of the at least two different and physically distinct computing devices, data generated by the one or more remotely located computing devices based at least in part on:
the data associated with the one or more security tests communicated by the first of the at least two different and physically distinct computing devices; and
the different data associated with the one or more security tests communicated by the second of the at least two different and physically distinct computing devices.

8. The method of claim 5, wherein executing the one or more aspects of the one or more security tests comprises communicating, by the one or more computing devices and to one or more third-party computing devices that are not a part of the distinctly identifiable local network and are not affiliated with the one or more remotely located computing devices, data associated with the one or more security tests.

9. The method of claim 1, wherein:
the at least a particular portion of the one or more networks comprises at least one or more Internet service provider (ISP) computing devices; and
executing the one or more aspects of the one or more security tests comprises communicating, by the one or more computing devices and to the one or more ISP computing devices, data associated with the one or more security tests.

10. The method of claim 1, wherein:
the at least a particular portion of the one or more networks comprises at least one or more domain name system (DNS) computing devices; and
executing the one or more aspects of the one or more security tests comprises communicating, by the one or more computing devices and to the one or more DNS computing devices, data describing one or more DNS queries associated with the one or more security tests.

11. The method of claim 10, wherein:
executing the one or more aspects of the one or more security tests comprises communicating, by the one or more computing devices and to the one or more remotely located computing devices, data describing one or more resolutions to the one or more DNS queries associated with the one or more security tests; and
receiving the data describing the one or more results of the one or more security tests comprises receiving data generated based at least in part on the one or more remotely located computing systems loading, within a controlled and isolated computing environment, one or more resources indicated by the data describing the one or more resolutions to the one or more DNS queries associated with the one or more security tests.

12. The method of claim 1, comprising:
receiving, by the one or more computing devices, from the one or more remotely located computing devices, and via the one or more networks, data describing one or more new security tests configured to cause the one or more computing devices to indirectly test security of the at least a particular portion of the one or more networks by communicating data to the one or more remotely located computing devices via the at least a particular portion of the one or more networks, the data describing the one or more new security tests having been generated, by the one or more remotely located computing devices, based at least in part on the data describing the one or more results; and
executing, by the one or more computing devices and based at least in part on the data describing the one or more new security tests, one or more aspects of the one or more new security tests with respect to the at least a particular portion of the one or more networks.

13. A system comprising:
one or more processors; and
a memory storing instructions that when executed by the one or more processors cause the system to perform operations comprising:
generating data describing one or more security tests configured to cause one or more computing devices to indirectly test security of at least a particular portion of one or more networks interfacing the system and the one or more computing devices;
communicating, to the one or more computing devices and via the one or more networks, the data describing the one or more security tests;
receiving, from the one or more computing devices and via the one or more networks, data generated in association with the one or more computing devices executing one or more aspects of the one or more security tests with respect to the at least a particular portion of the one or more networks;
generating, based at least in part on the data generated in association with the one or more computing devices executing the one or more aspects of the one or more security tests, data describing one or more results of the one or more security tests; and
communicating, to the one or more computing devices and via the one or more networks, the data describing the one or more results of the one or more security tests.

14. The system of claim 13, wherein:
the data describing the one or more security tests comprises data indicating one or more predetermined threat indicators; and
executing the one or more aspects of the one or more security tests comprises detecting data comprising at least one of the one or more predetermined threat indicators associated with a particular predetermined threat.

15. The system of claim 14, wherein the at least one of the one or more predetermined threat indicators comprises:
an internet protocol (IP) address associated with the particular predetermined threat;
a domain name associated with the particular predetermined threat;
a web-address reference associated with the particular predetermined threat;
a file associated with the particular predetermined threat;
a hash value generated based at least in part on a file associated with the particular predetermined threat;
an operating system (OS) command associated with the particular predetermined threat;
data from a domain name system (DNS) record associated with the particular predetermined threat;
data indicating a secure sockets layer (SSL) certificate associated with the particular predetermined threat;
data indicating a protocol payload associated with the particular predetermined threat; or
data indicating a query associated with the particular predetermined threat.

16. The system of claim 13, wherein the one or more networks comprise a distinctly identifiable local network that:
comprises the one or more computing devices;
comprises the at least a particular portion of the one or more networks; and
does not comprise the system.

17. The system of claim 13, wherein:
the at least a particular portion of the one or more networks comprises at least one or more Internet service provider (ISP) computing devices; and
executing the one or more aspects of the one or more security tests comprises communicating, by the one or more computing devices and to the one or more ISP computing devices, data associated with the one or more security tests.

18. The system of claim 13, wherein:
the at least a particular portion of the one or more networks comprises at least one or more domain name system (DNS) computing devices; and
executing the one or more aspects of the one or more security tests comprises communicating, by the one or more computing devices and to the one or more DNS computing devices, data describing one or more DNS queries associated with the one or more security tests.

19. The system of claim 13, wherein the operations comprise:
generating, based at least in part on the one or more results of the one or more security tests, data describing one or more new security tests configured to cause the one or more computing devices to indirectly test security of the at least a particular portion of the one or more networks;
communicating, to the one or more computing devices and via the one or more networks, the data describing the one or more new security tests; and
receiving, from the one or more computing devices and via the one or more networks, data generated in association with the one or more computing devices executing one or more aspects of the one or more new security tests with respect to the at least a particular portion of the one or more networks.

20. One or more non-transitory computer-readable media comprising instructions that when executed by one or more computing devices cause the one or more computing devices to perform operations comprising:
receiving, from one or more remotely located computing devices and via one or more networks interfacing the one or more computing devices and the one or more remotely located computing devices, data indicating one or more predetermined threat indicators and describing one or more security tests configured to cause the one or more computing devices to indirectly test security of at least a particular portion of the one or more networks by communicating data to the one or more remotely located computing devices via the at least a particular portion of the one or more networks; and
executing, based at least in part on the data describing the one or more security tests, one or more aspects of the one or more security tests with respect to the at least a particular portion of the one or more networks by detecting data comprising at least one of the one or more predetermined threat indicators associated with a particular predetermined threat.
